(19) United States
(12) Patent Application Publication
(10) Pub. No.: US 2025/0319500 A1
(43) Pub. Date: Oct. 16, 2025

(54) Clarity Case

(71) Applicants: Matthew Ashbaugh, Alexandria, VA (US); Katie Plitt, Alexandria, VA (US)

(72) Inventors: Matthew Ashbaugh, Alexandria, VA (US); Katie Plitt, Alexandria, VA (US)

(21) Appl. No.: 18/631,358

(22) Filed: Apr. 10, 2024

(51) Int. Cl. B08B 3/12; A45C 11/04; A45C 11/16; A61C 19/02

(52) U.S. Cl. CPC B08B 3/12; A45C 11/04; A45C 11/16; A61C 19/02

(57) ABSTRACT

The Clarity Case is a versatile and innovative cleaning and storage solution for compatible accessories like jewelry, glasses, orthodontic products, and more. It combines an integrated storage component with a detachable lower-level ultrasonic cleaner, allowing users to efficiently clean and store their accessories in a compact and portable device. Clarity Case enhances user convenience and provides a novel approach to cleaning and storage for consumer accessories.

### BACKGROUND OF THE INVENTION

The Clarity Case is a novel invention that addresses the need for an all-in-one cleaning and storage solution for compatible accessories, such as jewelry, glasses, orthodontic products, and more. This innovative apparatus combines an integrated storage component with a detachable lower-level ultrasonic cleaner, providing a convenient and compact solution for users. The integrated storage component is designed to be attached via multiple means, ensuring ease of use and portability.

This invention falls within the field of cleaning and storage solutions, particularly those designed for cleaning and storing accessories like jewelry, glasses, orthodontic products, and similar items. The Clarity Case aims to improve the user experience by integrating storage and ultrasonic cleaning capabilities into a single device.

### SUMMARY OF THE INVENTION

This invention falls within the field of cleaning and storage solutions, particularly those designed for cleaning and storing accessories like jewelry, glasses, orthodontic products, and similar items. The Clarity Case aims to improve the user experience by integrating storage and ultrasonic cleaning capabilities into a single device.

### BRIEF DESCRIPTION OF DRAWINGS

Three initial renderings have been provided for illustrative purposes only, as the Clarity Case can come in multiple sizes and configurations to accommodate different accessory sizes for versatility. Some components, such as the ultrasonic sensors, control buttons for the ultrasonic cleaner, associated wiring, and charging port are not included in the renderings but are integral to the functionality of Clarity Case.

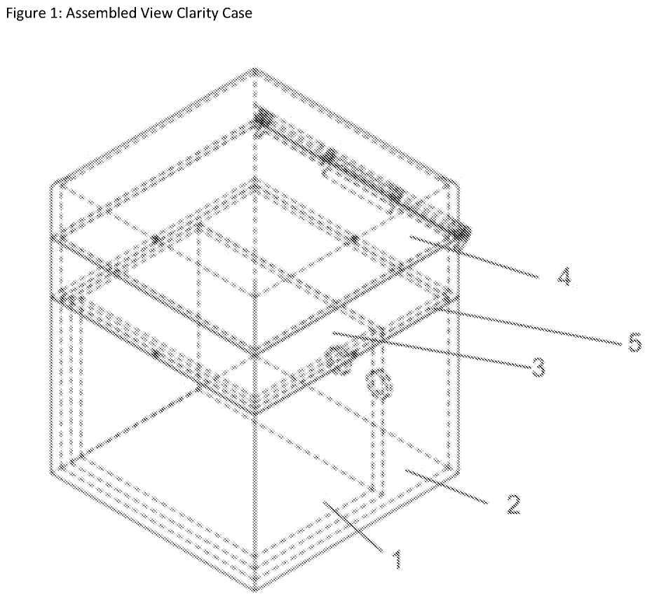

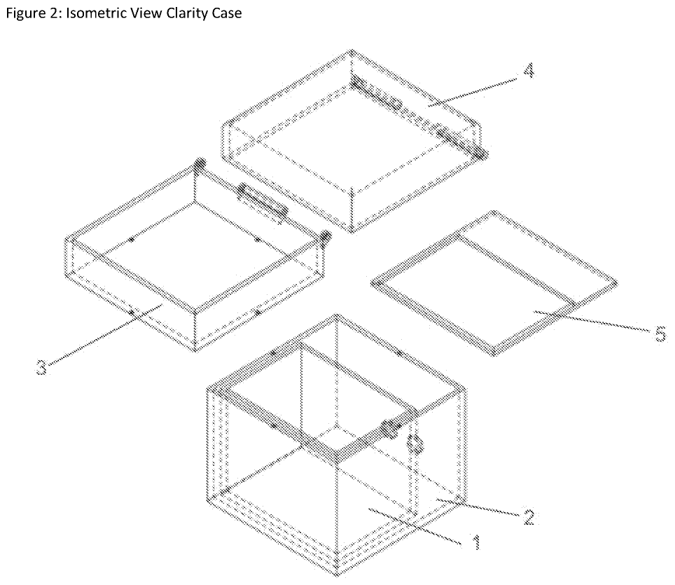

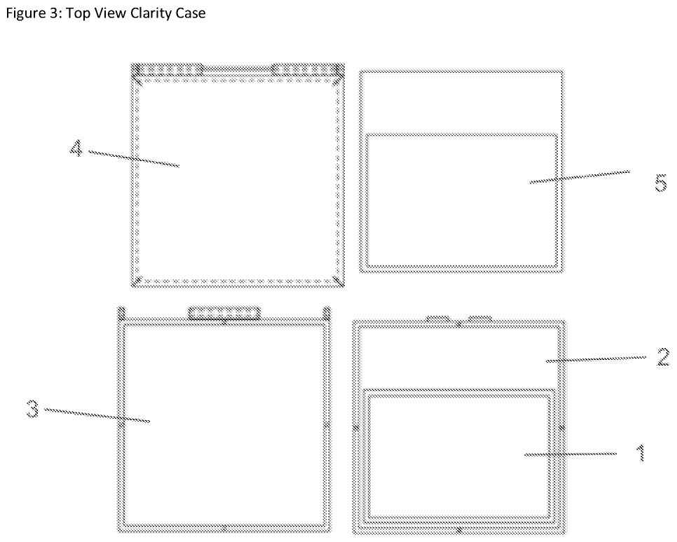

The three different renderings provided show assembled (FIG. 1), isometric (FIG. 2), and top (FIG. 3) views of the Clarity Case. The components displayed in each figure include the lower-level water basin (1) and a location for the ultrasonic sensors and associated wiring (2), cover plate for the lower-level ultrasonic cleaner (5), the two sections of the upper-level storage components (3 and 4), and buttons for the stop, start and power of the ultrasonic components.

### DETAILED DESCRIPTION OF THE INVENTION

The Clarity Case is designed to offer users a multifunctional tool for cleaning and storing a variety of accessories. The integrated storage components (3 and 4) are equipped with an opening that allows users to store their accessories conveniently. Clarity Case comes in multiple size options to accommodate different accessory sizes, ensuring flexibility and versatility.

The integrated storage components (3 and 4) of Clarity Case can be detached from the ultrasonic cleaner (1 and 2) when needed. To use the ultrasonic cleaner (1 and 2), the user fills its basin (1) with water and places the accessories inside. Integrated buttons allow users to control the start and stop of the ultrasonic sensor (2), ensuring ease of operation. A charging port will supply power to the ultrasonic cleaner (1 and 2) to allow for proper functionality.

Clarity Case leverages multiple means to secure the connections between the integrated storage components (3 and 4) and lower-level ultrasonic cleaner (1 and 2), making it user-friendly and portable. Users can easily attach and detach the components as needed, providing flexibility in their cleaning and storage routines.

Please note that the initial visual renderings provided in this application are for illustrative purposes only, as the Clarity Case can come in multiple sizes and configurations to accommodate different accessory sizes for versatility. Some components, such as the ultrasonic sensors, control buttons for the ultrasonic cleaner, associated wiring, and charging port are not included in the renderings but are integral to the functionality of Clarity Case.

1. An ultrasonic cleaning and storage device, referred to as “Clarity Case,” comprising:
a. An integrated storage component with an opening designed to store a variety of accessories;
b. A lower-level ultrasonic cleaner with a detachable basin for cleaning accessories;
c. A multiple-means-based attachment mechanism to secure the connections between the integrated storage component and the lower-level ultrasonic cleaner;
d. Integrated buttons for controlling the start, stop, and power of an ultrasonic sensor within the ultrasonic cleaner;
e. Associated wiring, charging port, and buttons to power on/off the Clarity Case.

2. The device according to claim 1, wherein the Clarity Case is available in multiple size options to accommodate different accessory sizes.

3. The device according to claim 1, wherein the multiple-means-based attachment mechanism allows users to easily attach and detach the integrated storage component and the lower-level ultrasonic cleaner.

4. The device according to claim 1, wherein the integrated buttons and associated wiring on the ultrasonic cleaner enable users to control the start, stop, and power of the ultrasonic sensor, thereby providing user-friendly operation.

5. The device according to claim 1, wherein the Clarity Case is designed to clean and store accessories such as jewelry, glasses, orthodontic products, and similar items.

6. The device according to claim 1, wherein the lower-level ultrasonic cleaner employs ultrasonic sensor technology to efficiently clean accessories submerged in water.

7. The device according to claim 1, wherein the combination of the integrated storage component and the lower-level ultrasonic cleaner provides a compact and portable cleaning and storage solution for accessories.

8. The device according to claim 2, wherein the multiple size options for the integrated storage component cater to a wide range of accessory sizes, ensuring versatility and convenience for users.

9. The device according to claim 3, wherein the multiple-means-based attachment mechanism facilitates easy attachment and detachment of the integrated storage component and the lower-level ultrasonic cleaner, offering user-friendly functionality.

10. The device according to claim 4, wherein the integrated buttons for controlling the ultrasonic sensor provide users with the ability to initiate and terminate the cleaning process as needed.
